(19) United States
(12) Patent Application Publication
(10) Pub. No.: US 2014/0015719 A1
(43) Pub. Date: Jan. 16, 2014

(54) SWITCHED ANTENNA APPARATUS AND METHODS

(71) Applicant: Pulse Finland Oy, Kempele (FI)

(72) Inventor: PRASADH RAMACHANDRAN, Oulu (FI)

(21) Appl. No.: 13/917,407

(22) Filed: Jun. 13, 2013

Related U.S. Application Data
(60) Provisional application No. 61/671,368, filed on Jul. 13, 2012.

(51) Int. Cl. H01Q 5/00

(52) U.S. Cl. CPC H01Q 5/0041; H01Q 5/0093
USPC 343/745

(57) ABSTRACT

Dynamically switchable antenna apparatus and associated methods. In one embodiment, a switching antenna configuration is used within a portable device (e.g. mobile phone). The switching antenna comprises at least one antenna element which operates at one or more resonant frequencies, and one or more switching elements. In one implementation, the switching elements are autonomously controlled to correct for detuning effects experienced by the antenna (e.g., body tissue loading) by modifying the electrical length of the antenna radiator(s) and/or correcting antenna impedance mismatch. In another implementation, the switching elements are controlled to effectuate band switching of the antenna.

This application claims priority to co-owned and co-pending U.S. Provisional Patent Application Ser. No. 61/671,368 filed Jul. 13, 2012 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNOLOGICAL FIELD

The present disclosure relates generally to antenna apparatus for use in electronic devices such as wireless or portable radio devices, and more particularly in one exemplary aspect to a chassis-excited antenna, and methods of tuning and utilizing the same.

### 2. DESCRIPTION OF RELATED TECHNOLOGY

Internal antennas are commonly found in most modern radio devices, such as mobile computers, mobile phones, Blackberry devices, smartphones, personal digital assistants (PDAs), or other personal communication devices (PCD). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency.

It is also a common requirement that the antenna operate in more than one frequency band (such as dual-band, tri-band, or quad-band mobile phones), in which case two or more resonators may be required to be used.

Typically, the aforementioned internal antennas are located on a printed circuit board (PCB) of the radio device, inside a plastic enclosure or are coupled to external metallic enclosure that permits propagation of radio frequency waves to and from the antenna(s).

Recent advances in the development of affordable and power-efficient display technologies for mobile applications (such as liquid crystal displays (LCD), light-emitting diodes (LED) displays, organic light emitting diodes (OLED), thin film transistors (TFT), etc.) have resulted in a proliferation of mobile devices featuring large displays, with screen sizes of up to 180 mm (7 in.) in some tablet computers and up to 500 mm (20 in.) in some laptop computers.

Furthermore, current trends increase demands for thinner mobile communications devices with large displays that are often used for user input (touch screen). This in turn requires a rigid structure to support the display assembly, particularly during the touch-screen operation, so as to make the interface robust and durable, and mitigate movement or deflection of the display. A metal body or a metal frame is often utilized in order to provide a better support for the display in the mobile communication device.

The use of metal enclosures/chassis and smaller thickness of the device enclosure create new challenges for radio frequency (RF) antenna implementations. Typical antenna solutions (such as monopole, PIFA antennas) require ground clearance area and sufficient height from the ground plane in order to operate efficiently in multiple frequency bands. These antenna solutions are often inadequate for the aforementioned thin devices with metal housings and/or chassis, as the vertical distance required to separate the radiator from the ground plane is no longer available, which severely limits the bandwidth of the antenna. Additionally, the metal body or chassis of the mobile device acts as an RF shield and degrades antenna performance, particularly when the antenna is required to operate in several frequency bands. Interaction with the user's anatomy or tissue, such as their hand or head (e.g., so-called “dielectric loading”) can have appreciable impact on the operation of the internal antenna, and must also be considered.

A variety of approaches to addressing the foregoing limitations and considerations are known in the prior art. For instance, in one approach, a slot antenna is used having a slot disposed on the PCB, which is fed. In this approach, a series switch is utilized to effect antenna band switching; this however causes additional insertion loss. Moreover, the matching level that can be achieved in such arrangements is limited, and hence the range of switching is limited.

In another approach, extra switching terminals are added to the radiator and connected to the ground through the switch, and a series impedance added between the switch and ground. In the case of multi-band antennas, the optimal position of this switching terminal is difficult to determine, and the addition of the switching terminal is not always possible (some specific physical limitations on implementations exist). Moreover, the addition of a new grounding terminal to the radiator enlarges the size of the antenna and the host device itself. Additionally, the directly connected lossy switch and introduction of impedance to the radiator can decrease efficiency, and suitable tune-ability in all bands is difficult to achieve.

A third prior art approach is based on using tunable capacitances. This solution is based on using a tunable capacitance (varactor diode) between the antenna radiator and ground. By changing the capacitance value, it is possible to switch/tune the resonance frequency of the antenna. This solution is very expensive, and at the same time requires varactors with the very large tunable capacitance ratios (more than 10:1 in the voltage range 0-3 Volts) to achieve desired frequency shift (e.g., between Tx and Rx typically). In the case of multi-band antennas, different varactors are required for different bands, thereby further increasing cost and space requirements. Moreover, varactors are not very linear devices, and hence cannot suitably handle high RF power levels. Hence, this varactor-based solution is not well suited for the Tx bands in most cases, where a high RF transmission power would de-tune the antenna's resonant frequency.

Another approach is based on one transmission line coupled to the radiating element. The effective length of transmission line is changed using an adjustment mechanism. This approach disadvantageously provides the ability to only tune one resonance, even if used with a multi-resonance antenna. The band, which is not subject to tuning, is also uncontrolled. Conversely, to add several separate transmission lines and control circuits to one antenna is impractical because of high cost and increased complexity.

Still another approach is to utilize an extra parasitic patch, which increases the antenna size, and is not efficient for devices of the dimension of a typical handheld mobile terminal, and can be used effectively only in larger devices e.g. tablet, laptops etc. Moreover, when it is desired to control/tune/switch more than one frequency band, it is very complicated or impossible to find an optimal location within the host device where sufficient coupling can be achieved between all bands/resonances under control.

Accordingly, there is a salient need for an improved antenna solution that can effectively cause the antenna resonant frequency to operate in the desired frequency band, as well as compensating for antenna mismatch and detuning effects caused by the presence of a dielectric change (e.g. hand) at a lower cost and complexity, and which provides for improved control of antenna resonance, and methods of tuning and utilizing the same.

### SUMMARY

The present disclosure satisfies the foregoing needs by providing, inter glia, improved apparatus and methods for antenna construction and control.

In a first aspect of the disclosure, an antenna circuit for use in a mobile device is disclosed. In one embodiment, the circuit includes: at least one feed; a single antenna radiating element; a transmission path disposed between the at least one feed and the radiating element. In one variant, the path comprises first and second inductors and first and second nodes disposed between (i) the first and second inductors, and (ii) the second inductor and the radiating element, respectively. First and second switching apparatus each including in one implementation a switching element having a first plurality of states, and at least one filter circuit in electrical communication with the switching element and disposed electrically between the switching element and the first node are also provided. The first and second switching apparatus are operable to switch among the first and second plurality of states, respectively, so as to allow for various functions. These functions may include, e.g., operation of the single radiating element in different frequency bands, compensation for dielectric loading of the antenna, and/or different configurations of the antenna's matching network (e.g., shunt elements show high impedance such that the antenna sees only inductive/capacitive element(s) in series in one state, and at least one (or all) of the series components form a part of the matching network in another state).

In a second aspect of the disclosure, switching apparatus for use with an antenna is disclosed. In one embodiment, the apparatus includes: at least one switching element having a plurality of states; and at least one filter circuit in electrical communication with the at least one switching element and disposed electrically between the switching element and an antenna signal transmission path. The at least one switching element can be switched between ones of the plurality of states so as to effect respective different operating conditions.

In a third aspect of the disclosure, multi-band antenna apparatus is disclosed. In one embodiment, the antenna apparatus includes a feed; a single radiating element; and a transmission path between the feed and radiating element. The transmission path comprises switching apparatus in communication therewith but not electrically disposed within the path, and is configured to effect changes in electrical length of the radiating element so as to enable operation of the antenna apparatus in two or more desired frequency bands.

In one variant, the antenna apparatus is configured to fit within, and be operable in the two or more desired frequency bands of, a low vertical height mobile wireless device having at least one metallic structural component proximate the antenna apparatus.

In a fourth aspect of the disclosure, self-compensating antenna apparatus is disclosed. In one embodiment, the apparatus includes: a feed; a single radiating element; control apparatus; and a transmission path between the feed and radiating element. The transmission path comprising switching apparatus in communication therewith, and the control apparatus configured to control the switching apparatus to effect changes in electrical length of the radiating element so as to compensate for dielectric loading of the antenna apparatus which detunes the radiating element from its desired operational frequency.

In one variant, the control apparatus is either: (i) open loop with switchable circuitry; or (ii) closed loop computerized control logic.

In a fifth aspect of the disclosure, a mobile wireless device is disclosed. In one embodiment, the mobile device includes: a cellular transceiver; at least one radiating element in signal communication with the transceiver via a signal transmission path; and switch circuitry in communication with the transmission path configured to selectively alter the electrical length of the at least one radiating element so as to at least enable: (i) operation in multiple cellular frequency bands of interest; and (ii) compensation for detuning caused by one or more external influences imposed upon the mobile device.

In one variant, the mobile device is a very thin form-factor mobile telephone, tablet, or smartphone having at least some metallic case or housing elements in proximity to the antenna radiating element.

In a sixth aspect of the disclosure, methods for compensating for various types of dielectric loading of a wireless device are disclosed. In one embodiment, the loading is imposed by a user's anatomy coming in contact with the device, and the method include selectively operating one or more switchable elements in the device's antenna tuning circuitry to change the effective electrical length of one or more radiators of the antenna.

In a seventh aspect of the disclosure, methods for operating a single radiating element of a wireless device antenna are disclosed. In one embodiment, the methods include selectively actuating one or more switchable elements within the antenna's tuning circuitry to vary the electrical length of the single radiating element, thereby causing a shift in its resonant frequency to a desired band.

In an eighth aspect of the disclosure, methods for tuning an antenna using switchable elements and filter circuitry are disclosed.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIG. 1 is a schematic diagram illustrating an exemplary implementation of the switching antenna apparatus configured in accordance to the present disclosure.

FIG. 2 is an isometric view an exemplary mobile device form factor, comprising switching antenna apparatus configured according to FIG. 1.

FIG. 3 is an exploded isometric view of the exemplary mobile device of FIG. 2A, showing the various components thereof.

FIG. 4 is a plot of free-space return loss (in dB) as a function of frequency, measured in a (i) free space operation of the antenna, (ii) a detuned state of the antenna, and (ii) various compensation states.

FIG. 5 is a plot of total antenna efficiency measured with an original antenna and the antenna with an exemplary switching antenna apparatus configured according to FIG. 1.

FIG. 6 illustrates exemplary total radiated power (TRP) data for a test setup of the original antenna and the antenna with an exemplary switching antenna apparatus configured according to FIG. 1.

All Figures disclosed herein are © Copyright 2012-2013 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

The term “near field communication (NFC)” refers without limitation to a short-range high frequency wireless communication technology which enables the exchange of data between devices over short distances, such as for example described by ISO/IEC 18092/ECMA-340 standard and/or ISO/ELEC 14443 proximity-card standards.

As used herein, the terms “portable device”, “mobile device”, “client device”, “portable wireless device”, and “host device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” and “radiating element” refer without limitation to an element that can function as part of a system that receives and/or transmits radio-frequency electromagnetic radiation; e.g., an antenna.

The terms “RF feed,” “feed” and “feed conductor” refer without limitation to any energy conductor and coupling elements) that can transfer energy, transform impedance, enhance performance characteristics, and conform impedance properties between an incoming/outgoing RF energy signals to that of one or more connective elements, such as for example a radiator.

As used herein, the term “inductive device” refers to any device using or implementing induction including, without limitation, inductors, transformers, and inductive reactors (or “choke coils”).

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

### Overview

The present disclosure provides, in one salient aspect, a switching antenna apparatus for use in e.g., a mobile device, which advantageously provides reduced size and cost, and improved antenna performance. In one embodiment, the switching antenna apparatus includes switches with switching inputs connected to the transmission line that contain reactive components in series, with the transmission line connecting the antenna and RF feed point of the mobile device.

In one implementation, the switching antenna apparatus is designed to adjust the reactive value of the series components by selectively switching between the different switching outputs of the switches, thereby allowing electrical adjustment of the antenna radiator's electrical length, and/or adjustment of the impedance of the transmission line. By adjusting the electrical length of the antenna radiator, the antenna may operate in a number of possible operating frequencies without the need for use of additional radiators or other antennas (e.g., parasitic patches or the like), respective transmission lines, and/or control circuitry to operate between the multiple antennas. In addition, the series switching apparatus can perform tuning adjustments to compensate for detuning effects experienced by the antenna, and/or correct impedance mismatch to improve antenna efficiency.

The switching antenna apparatus as in the embodiments described herein allows for actively switching the resonant frequency of the antenna to implement band switching on the respective mobile device, while also allowing for the device to maintain a thinner and more compact form factor. In addition, the series switching antenna apparatus disclosed herein can advantageously be used to compensate for detuning effects experienced by the antenna, such as being placed under various dielectric loading conditions (e.g., contact with a user's body tissue, such as a hand or head), thus further improving antenna performance.

### DETAILED DESCRIPTION OF EXEMPLARY EMBODIMENTS

Detailed descriptions of the various embodiments and variants of the apparatus and methods of the disclosure are now provided. While primarily discussed in the context of mobile devices, the various apparatus and methodologies discussed herein are not so limited. In fact, the apparatus and methodologies of the disclosure may be useful in any number of complex antennas, whether associated with mobile or fixed devices.

### Exemplary Series Switching Antenna Apparatus

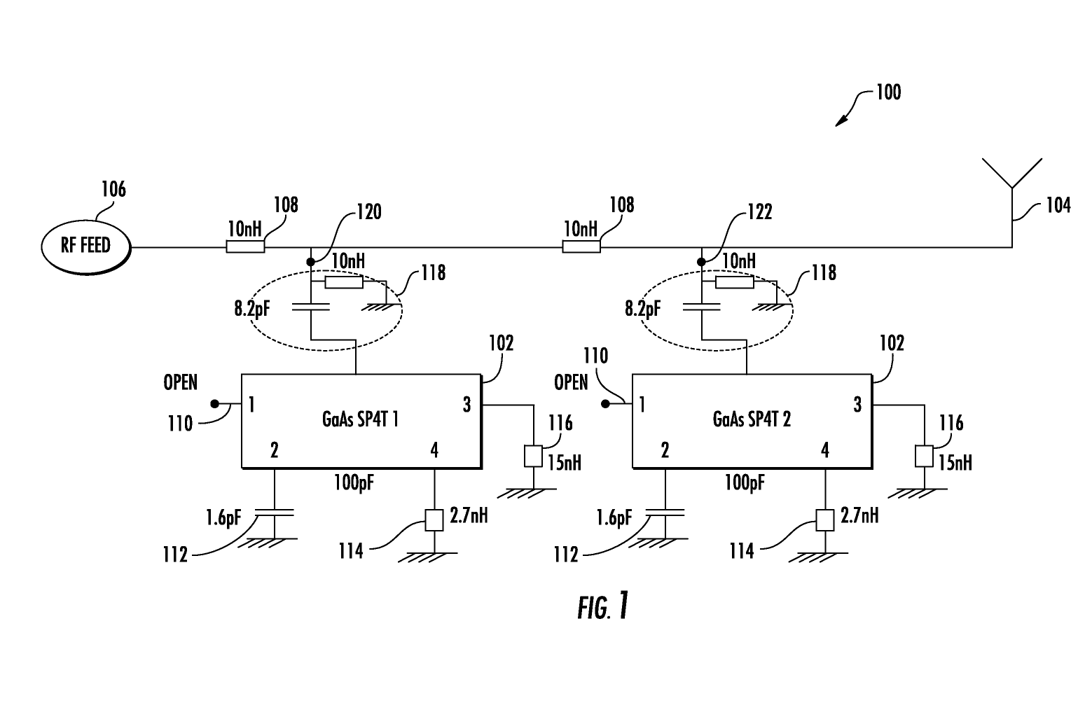

Referring now to FIG. 1, an exemplary embodiment of the switching antenna apparatus 100 configured in accordance with the principles of the present disclosure is shown and described. The illustrated switching antenna apparatus 100 comprises an antenna element 104, an RF feed point 106, and switching elements 102. While the exemplary embodiment only illustrates the use of one RF feed point, two switching elements, and one antenna element, the present disclosure is not so limited, and may be implemented with any number of RF feed points (e.g. two-feed, three-feed), as well as any number of antenna elements and/or switching elements as may be required by the particular application.

In one embodiment, the switching antenna apparatus 100 is used for implementing band switching. Band switching allows the antenna element 104 to operate at a number of possible resonant frequencies by actively changing the electrical (length) characteristics of the antenna element's radiator. In one implementation, the switching elements 102 comprise single-pole multi-throw (e.g., single-pole quadruple throw, or SP4T) switches. While SP4T switching elements are used in the illustrated embodiment, any number of alternate switching configurations or devices may be employed consistent with the disclosure, whether alone or in combination with the SP4Ts. For instance, the switching elements 102 may be implemented via a variety of technologies such as microelectromechanical (MEM) switches, GaAs switches, CMOS switches, capacitor banks, etc. Alternatively the two SP4T switches can be replaced with one nPnT (DPDT, DP4T etc) switch, or the two SP4Ts can instead be replaced with a single chip tuner.

The antenna element (with radiator) 104 may be implemented with any suitable antenna technology. For example, micro-strip, patch, loop antennas, inverted L antennas (ILA), planar inverted L antenna (FILA), left- or right-circular polarized, or variations thereof may be used consistent with the disclosure.

As a brief aside, the effective electrical length of the antenna element 104 can be electrically adjusted through the use of suitable electronic devices such as, for example, reactive components (e.g., capacitors, inductors, etc.). Accordingly, the resonant frequency of the antenna element 104 may be modified from the resonant frequency that would otherwise be predicated on the physical length of the radiator of the antenna element 104, A salient advantage of electrically increasing the length of the radiator in this manner is that the size of the physical antenna can be reduced, and thus fit into smaller form factor devices, while still maintaining the resonant frequency that would otherwise require a larger antenna.

In one exemplary embodiment, the series switching antenna apparatus 100 is designed to operate between two or more resonant frequencies. The operating resonant frequency is controlled by selectively switching between the pluralities of available reactive component values made available at the switching legs of the switching elements 102. Thus, by changing the reactive component values of the circuit, the switching apparatus 100 adjusts the electrical length of the radiator of the antenna element 104, thereby changing the operating resonant frequency or frequencies.

The reactive component at the switching elements 102 output can be a combination of lumped reactances (e.g. discrete inductors and capacitors) and distributed reactances (transmission lines), or just one of the aforementioned reactances.

On salient advantage of the present disclosure is that band switching between one or more operating bands can be achieved using only one transmission line, and without requiring additional antenna elements or additional switching elements. Accordingly, by obviating additional transmission lines and/or antenna elements, and respective control circuitry, the complexity, size, and cost of the respective device is reduced.

In one implementation, the switching antenna apparatus 100 comprises inductive elements 108 in series on the transmission line between the antenna element 104 and the RF feed point 106. The switching elements 102 (GaAs SP4Ts) each comprise an open connection 110, capacitive element 112, and two different values of inductive elements 114, 116. One salient advantage of the present disclosure is that the switching elements 102 are not in series on the transmission line between the RF feed point 106 and antenna element 104, and thus do not add additional insertion loss, while still allowing for selectively tuning/switching the antenna element 104.

The input of the switching element in the exemplary implementation further comprises a high-pass filter 118, comprising a capacitive element and an inductive element placed between the switching elements 102 and the transmission line. In one variant, the high-pass filter 118 is designed for electrostatic discharge (ESD) protection of the switching elements. However, one skilled in the art will appreciate that the present disclosure is not limited to the use of a high-pass filter. The circuit of FIG. 1 can be also implemented using any different topology for the mentioned filter. The reason for using such different topology could be, for example, a need for the different ESD protection. It is also possible to use different filter types (as low-pass, band-pass and band-stop filters), if for example there is a need to avoid switching of any of the present frequency bands, and thus implement only switching in some of bands (in for example only one band).

In the exemplary implementation, switching elements are selected to appear as high impedance at the intermediary nodes 120, 122 by selecting the switching element outputs to the open circuit. It is noted that the GaAs switch (or any other switch for that matter) has an internal delay; i.e. the electrical length from output of the switch to the input of the switch. Further, the introduction of the filter at the input of the switch increases this delay. Hence as an e.g. “open” state (pin 1 of 102a) will not be shown an “open or high impedance” at the node 120. Instead, in this particular implementation, the value of 1.6 pF shows an “open” impedance at node 120, and similarly for node 122. Furthermore, this delay is dependent on frequency, and hence the component value to show an “open” will be different for the low frequency band and for the high frequency band. When the nodes 120 and 122 show very high impedance, the RF currents will not flow through those branches. Hence, all the currents are forced to flow through the series inductors 108. In this state, the antenna has both inductors 108 as series elements, and hence the length of the radiator is the longest, and the resonant frequency the lowest. When there is a need to change the resonant frequency of the antenna to a higher value (e.g., either for band switching or to compensate for the loading by the hand of the user), the electrical length of the radiator needs to be affected. It is well known that as the length of the radiator changes, so does also its impedance. Hence in a first case, a different state on the switch 102a is selected. This new state is selected based on the impedance of the antenna. When a state different than that associated with element 112 is selected, the combination of components 102a and 108a (closer to the RF feed) act as an L-section matching circuit.]

In one variant, the component values of the inductive elements 108a and 108b are selected such that, when the switching elements 102a or 102b are switched to the output 112, the antenna element 104 operates at the lowest supported resonant frequency. Accordingly, the resonant frequency of the antenna element 104 may be dynamically adjusted by selecting between the different outputs of the switching elements 102a, 102b. For example, if switching element 102 switched from the open circuit output 110 to an inductive element output, the inductive value seen at series inductance element would decrease.

As an aside, in the exemplary case of use of an inductor or capacitor with a semiconductor switch, these inductive and capacitive components are seen as different impedance values. The impedance can be on the inductive or capacitive region of the well-known Smith chart. In the case of a relay type of switch (e.g. ohmic MEMS), a capacitor or inductor will be seen as “pure” component, and can form a part of the antenna radiating structure. In other cases, these components are only part of the impedance matching of the antenna for the confined electromagnetic waves. As the other switching element 102b remains switched to 112, and thus appears to the apparatus as high impedance, the inductance value of its respective series inductive element remains unchanged. However, the series inductance seen between the antenna element 104 and the RF feed point 106 has been reduced. Accordingly, the reduced inductance of the series circuit decreases the electrical length of the antenna element's radiator, thereby causing an upshift in the resonant frequency of the antenna element 104.

It will also be recognized that the switching antenna apparatus 100 may additionally selectively choose between the switching element 102a and 102b outputs in order to improve antenna matching, or further modify or fine-tune the resonant frequency of the antenna element 104.

Another salient advantage of the present disclosure is that any number of resonant frequencies can be supported by a single device by properly configuring the number of switching elements 102, and respective switching outputs to support the desired resonant requirements. For example, the switching antenna apparatus 100 illustrated in FIG. 1 is configured to support different operating bands, for example, such as GSM850 and GSM900 and GSM1800 and GSM1900. The switching antenna apparatus 100 may also be implemented to support the transmit (Tx) and receive (Rx) bands of one system, for example 850-Tx and 850-Rx, or any combination of bands and systems which are time division multiplexed.

In addition, the number of operating bands of one resonance is not limited to one band. By using the switching elements 102 and certain circuit configuration(s) (e.g. L-C networks) at the switch element 102 outputs, one resonance can operate at multiple (n) bands, such as for example through use of an SPnT switching arrangement comparable to that shown in FIG. 1. In one implementation, the antenna element 104 can additionally have unlimited number of resonance frequencies which are not tuned by a tuning circuit, for example through implementation of a parasitic resonator whose frequency is not tuned.

In one embodiment, the series switching antenna apparatus 100 is designed for compensating for detuning effects experience by the antenna element 104. For example, the antenna element 104 may be tuned in operate at a desired resonant frequency when operating under a free-space condition. However, when the antenna element 104 (and its respective device) is placed under a different dielectric operating condition, such as being loaded by a user's body tissue (e.g., hand or head) or in contact with a conductive surface, the antenna element 104 may detune to a different frequency. In the instance of a user's body tissue, the dielectric loading may cause the antenna element 104 to be affected, thereby changing the resonant frequency away from the desired operating frequency and resulting in the detuning. In addition, the changed dielectric loading condition may cause impedance mismatch of the antenna circuit, causing a negative impact on the antenna's efficiency.

One salient advantage of the present advantage is that the switching elements 102 allow for dynamic adjustment or compensation for the aforementioned detuning effect. For example, if the effect of a loading condition (e.g. user body tissue) causes the resonant frequency of the antenna element 104 to shift to a lower resonant frequency than the desired operating resonant frequency, the switching antenna apparatus 100 circuitry can compensate for this detuning effect by adjusting the electrical length of the radiator of the antenna element 104. Accordingly, in the example of the antenna detuning to a lower resonant frequency, the radiator's electrical length can be decreased by switching the switching element(s) 102 output to the output having the appropriate reactive component values. By decreasing the radiator's electrical length, the resonant frequency of the antenna element 104 will increase to compensate for the detuning effect. In the opposite case (i.e., the antenna element detuning to a higher resonant frequency), the switching elements 102 can select the suitable reactive component values in order to extend the electrical length of the antenna element 104 to decrease the resonant frequency to compensate for the detuning change in frequency. Furthermore, impedance mismatch experienced at the antenna element 104 due to the loading condition may be corrected by the one or more switching elements by selecting a suitable switch output. As explained supra, when an output state other than that via element 112 is selected, the switch 102a with the inductor 108a forms a L-section matching network. By selecting different components at the output of the switch, different impedance transformations can be chosen. In the present exemplary implementation, three (3) states of switching other than via element 112 (open at node 120) are utilized, but substitution of a capacitor bank can provide a diversity of various L-section matchings.

In one embodiment of the disclosure, the switching elements 102 of the apparatus 100 of FIG. 1 are controlled by the host device. In one implementation, the processor of the device (e.g., application processor, baseband processor, etc.) controls the switching elements 102 and their selected outputs. For example, the processor of the device may be equipped or in communication with detection circuitry to identify the occurrence of a detuning event, and implement the appropriate corrective action (e.g., increase or increase the electrical length of the radiator by an appropriate amount). To this end, the processor may also include algorithms running thereon which monitor and implement corrective action via the switching circuitry. These algorithms may also be configured to optimise various aspects of antenna or device operation, such as during loaded conditions as described above.

In the case of band switching, the aforementioned processor controls the desired operating resonant frequencies, and effects band switching by controlling the switching elements 102. For instance, such band switching may be desirable when a different operating frequency is desired or needed (e.g., in the presence of interference or jamming at a given frequency, movement to another territory or country which uses a different band of a given air interface standard, etc.).

In another variant, the switching elements 102 may be controlled by detection circuitry not otherwise associated with the processor of the respective device. Accordingly, the operation of the one of more frequency bands may be adjusted without direct intervention by the host device.

Variants that are user- or technician-controllable are also envisioned, such as via user input via a touch screen or other user interface of the host device.

In yet another implementation, a combination of the aforementioned switching control implementations may be employed. For example, the device processor may be responsible for controlling the switching of the switching elements in the case of band switching, whereas the separate detection circuitry is responsible for controlling the switching elements in the case of compensating for detuning/impedance mismatch. One exemplary mechanism useful for control of the aforementioned switching functions is described in co-owned U.S. application Ser. No. 13/505,734 entitled “Adjustable Antenna Apparatus and Methods” filed Oct. 2, 2012, which claims priority to PCT/FI2010/050821 filed on Oct. 20, 2010, which claims priority to Finland Application No. FI 20096134 filed Nov. 3, 2009, each of the foregoing being incorporated herein by reference in its entirety. Additionally, other mechanisms or approaches may be used consistent with the present disclosure, including e.g., e.g. a VSWR monitor or phase detector.

### Exemplary Mobile Device Configuration

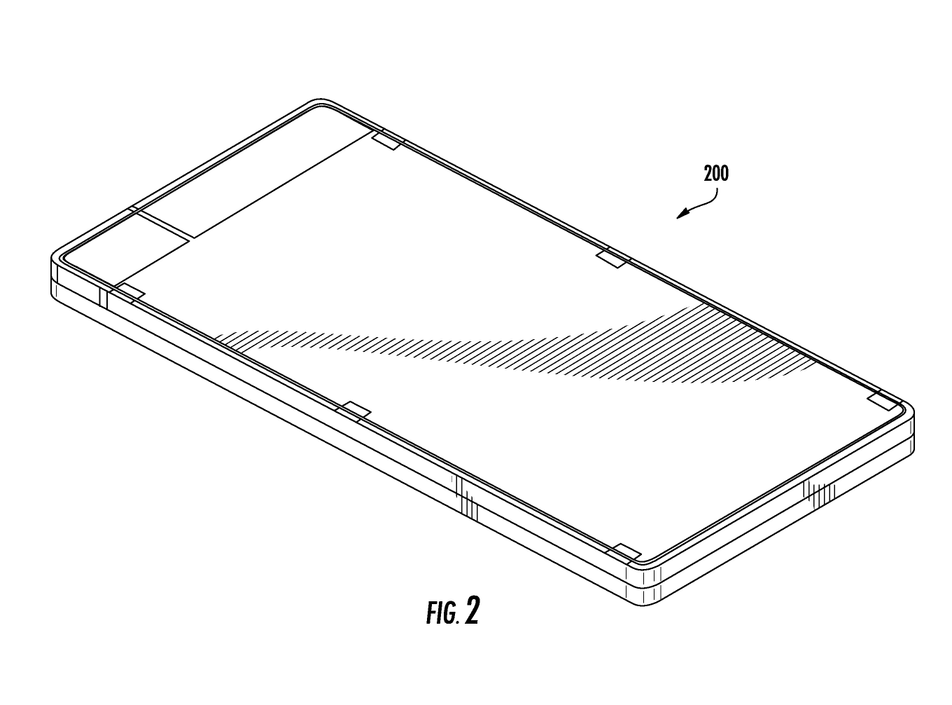

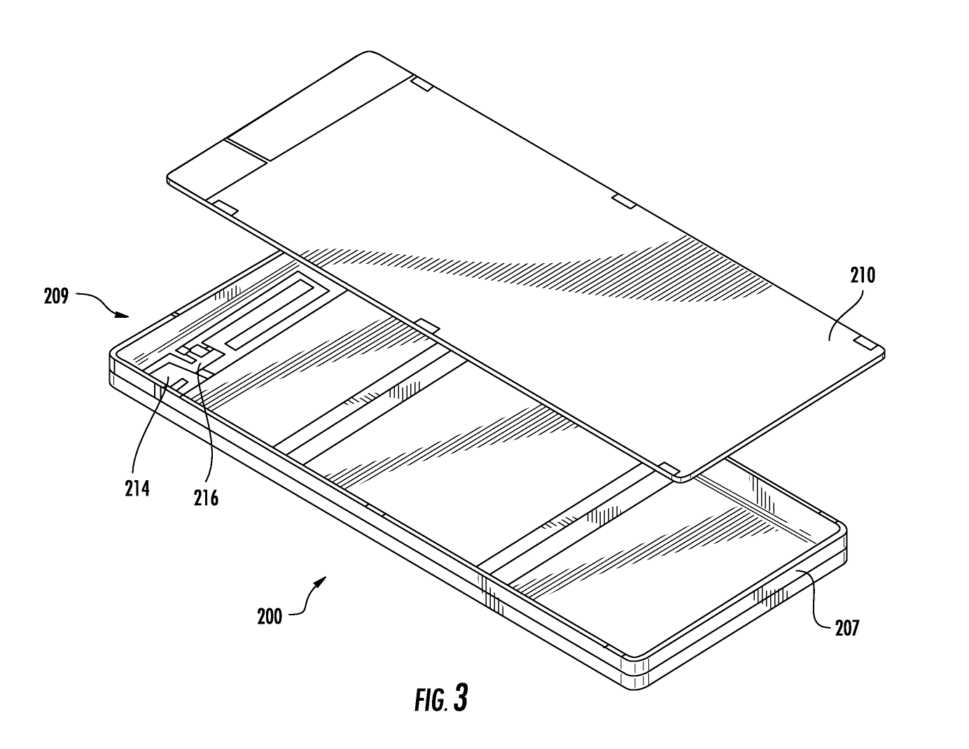

Referring now to FIGS. 2 and 3, an exemplary embodiment of a mobile device 200 comprising the switching antenna apparatus configured in accordance with the principles of the present disclosure is shown and described. While a “thin” form factor mobile cellular telephone/smartphone is illustrated, it will be appreciated that the disclosure may be employed in any type of device (whether mobile or otherwise), including without limitation tablet computers, laptop computers, phablets, etc.

The exemplary mobile device comprises an enclosure 202 which may be fabricated from a variety of materials, such as, for example, suitable plastic and/or metal, and which supports a display module (not shown). In one variant, the display comprises a touch-screen device with interactive functionality. Notwithstanding, the display may comprise e.g., a display-only device configured only to display information, a touch screen display (e.g., capacitive, resistive, or other technology), or yet other type (such as organic LED (OLED) or the like), and may utilize any number of technologies such as LED, LCD, TFT, etc. In one implementation, the enclosure comprises a front cover and a rear cover. The cover elements are in this embodiment also fabricated from any suitable dielectric material (e.g. plastic, composite, glass) and are attached to the device by a variety of suitable means, such as e.g., adhesive, press-fit, snap-in with support of additional retaining members (not shown), or the like. Alternatively, the covers may be fabricated from a non-conductive film, or non-conductive paint bonded onto one or more exterior surfaces of the radiator element(s).

FIG. 3 shows the embodiment of the mobile device 200 of FIG. 2 with the covers separated, so as to reveal internal components and structures of device 200. In one embodiment, the device comprises an internal main printed circuit board 210 (PCB).

The device 200 further comprises a switching circuit PCB 214 which includes the switching antenna apparatus and circuitry previously described with respect to FIG. 1. In one implementation, the switching circuit PCB 214 comprises a “flex” PCB that is separate from the main PCB 210. In another implementation, the switching PCB 214 is implemented as part of the main device PCB 210. In yet another implementation, the switching antenna apparatus can be implemented across both the main PCB and a separate switching PCB 214.

The device further 200 comprises an antenna radiator 216. The antenna 216 may be constructed with a number of suitable means, for example, flex, ceramic, sheet metal, plated plastic parts (e.g. laser direct structuring (LDS)) or other suitable technologies can be used to create this type of structure. As yet another alternative, a printed antenna of the type described in co-pending U.S. patent application Ser. No. 13/782,993 filed on Mar. 1, 2013, and which claims priority to Mar. 2, 2012, entitled “Deposition Antenna Apparatus and Methods” and incorporated herein by reference in its entirety, may be used consistent with the present disclosure. The placement of the antenna 216 on the device 200 in the exemplary implementation is on the bottom portion of device 200, but may be chosen based on the device's specification, and to support the desired resonance frequency (or frequencies).

In one implementation, the antenna radiator 216 is designed to operate in a chassis mode by coupling to the chassis of the host device 200 (e.g., metal ring 207) or another suitable structure to act a part of the antenna's radiator. In one variant, the antenna comprises a loosely coupled inverted-L antenna (ILA), which is achieved via placement of the ILA antenna outside of the internal chassis 208. However, any suitable antenna technologies may be implemented with the present disclosure, for example and without limitation, patch antennas, slot antennas, loop antennas, planar inverted F antennas (PILA), or any combination thereof.

In another implementation, the antenna operates at additional resonant frequencies not controlled by the switching circuit PCB; for example, the antenna may include parasitic resonator 209 whose frequency is not tuned, but which increases the number of possible resonant frequencies supported by the device 200.

In another embodiment, the device 200 comprises two or more antennas, configured in accordance with the principles of the present disclosure, which operate in the same frequency band thus providing, inter alia, diversity for Multiple In Multiple Out (MIMO), Multiple In Single Out (MISO), or similar multi-radiator element applications.

In yet another embodiment, one of the frequency bands associated with the antenna (and switching circuitry) comprises a frequency band suitable for Near Field Communications (NFC) applications, e.g., ISM 13.56 MHz band. Such NFC communications are useful for, inter alia, mobile device contactless payment systems such as Google Wallet™ and ISIS™.

Other implementations of the disclosure configure the antenna to cover LTE/LTE-A (e.g., 698 MHz-740 MHz, 900 MHz, 1800 MHz, and 2.5 GHz-2.6 GHz), WWAN (e.g., 824 MHz-960 MHz, and 1710 MHz-2170 MHz), WLAN, and/or WiMAX (2.3, and 2.5 GHz) frequency bands. Yet other frequency bands (cellular, WWAN, WLAN, WMAN, GPS/GLONASS, PAN (e.g., Bluetooth), or otherwise) are achievable with the antenna switching apparatus disclosed herein as well.

As persons skilled in the art will appreciate, the frequency band composition given above may be modified as required by the particular application(s) desired, which may further include multiple types of air interfaces within the same device (e.g., hybrid or multi-interface cellular, as well as WLAN and PAN and GPS). The present disclosure contemplates yet additional antenna structures within a common device (e.g., tri-band or quad-band) with one, two, three, four, or more separate antenna assemblies where sufficient space and separation exists. Each individual antenna assembly can be further configured to operate in one or more frequency bands. Therefore, the number of antenna assemblies does not necessarily need to match the number of frequency bands.

### Performance

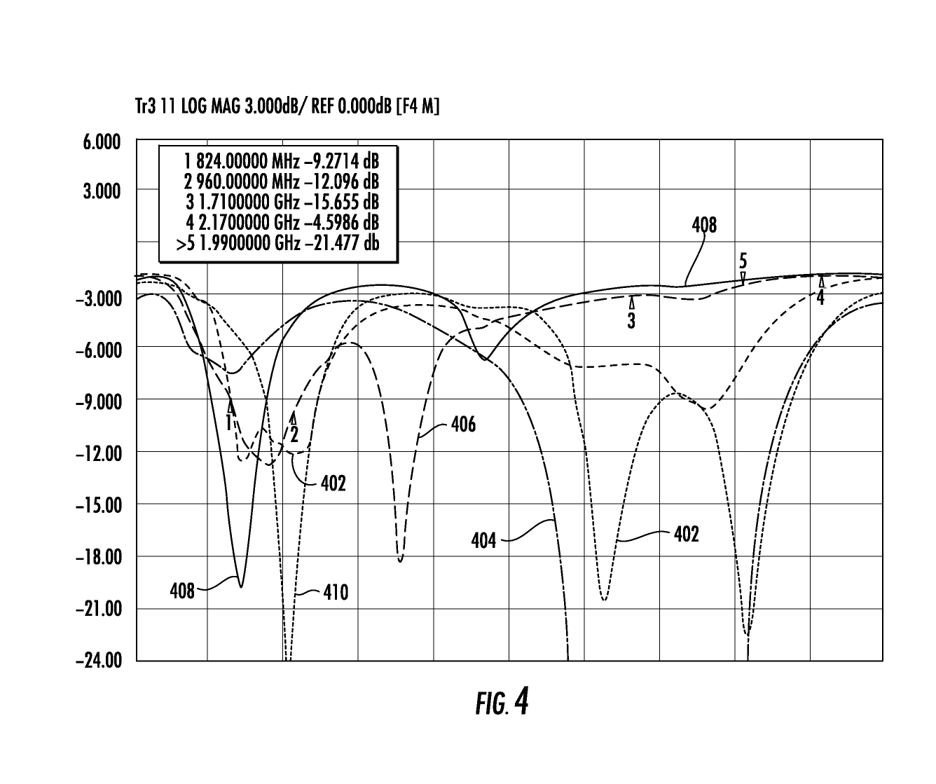

Referring now to FIGS. 4 through 6, performance results obtained during testing by the Assignee hereof of an exemplary antenna apparatus constructed according to the disclosure are presented.

FIG. 4 shows a plot of free-space return loss (in dB) as a function of frequency, measured between 820 MHz to 2 Ghz. As illustrated, the plot shows (i) free space operation of the antenna, (ii) a detuned state of the antenna, and (ii) various compensation states. The various compensation states are designed in the exemplary implementation to optimize performance in the band of interest. For instance, the hand effect-based adaptivity focuses mainly the low band in the illustrated implementation. The first curve (“TR1” 402) given in FIG. 4 is for the freespace condition. The second curve (“TR2” 404) is for the “detuned” detuned condition; i.e., in user's hand. The remaining states (“TR3” 406, “TR4” 408, and “TR5” 410) are “compensated” states showing S11 by choosing different component combinations from the switches 102a and 102b.

Hence, the exemplary switching antenna apparatus of FIG. 1 allows for an antenna to be compensated to support a wide range of operating frequencies. This capability advantageously allows operation of a portable wireless device with a single antenna over several mobile frequency bands such as GSM710, GSM750, GSM850, GSM810, GSM1900, GSM1800, PCS-1900, as well as LTE/LTE-A and WiMAX (IEEE Std. 802.16) frequency bands. As persons skilled in the art appreciate, the frequency band composition given above may be modified as required by the particular application(s) desired, and additional bands may be supported/used as well.

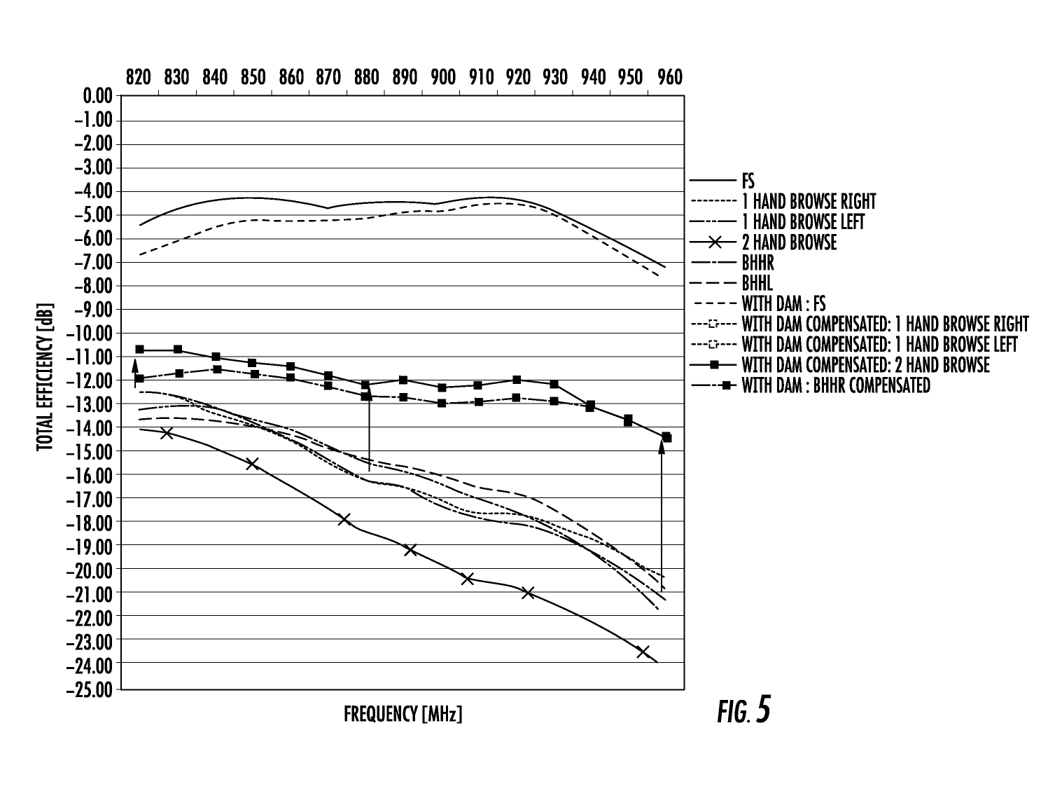

FIG. 5 illustrates exemplary total antenna efficiency for a test setup of an original (unmodified) antenna, and the antenna with an exemplary switching antenna apparatus (e.g., that of FIG. 1 herein) configured according to one embodiment of the present disclosure. The data for the two antennas represents operation under various different operating conditions. The antenna efficiency (in dB) is defined as decimal logarithm of a ratio of radiated and input power:

$$AntennaEfficiency = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy. The illustrated operating conditions include a free-space condition as well as multitude of human operator loading conditions, such as hand browser right, hand browse left, two-hand browse, beside head hand right (BHHR), and beside head hand left (BHHL). As illustrated in FIG. 5, the original antenna and the inventive antenna with the switching antenna apparatus have comparable efficiency when operating in free-space. However, when the antenna is operating under a loading condition (for example BHHR), the antenna compensated with the antenna switching apparatus of the present disclosure has appreciable improvement in antenna efficiency compared to the original antenna. In the exemplary testing arrangement, the improvement in efficiency is even more apparent as the operating frequency increases.

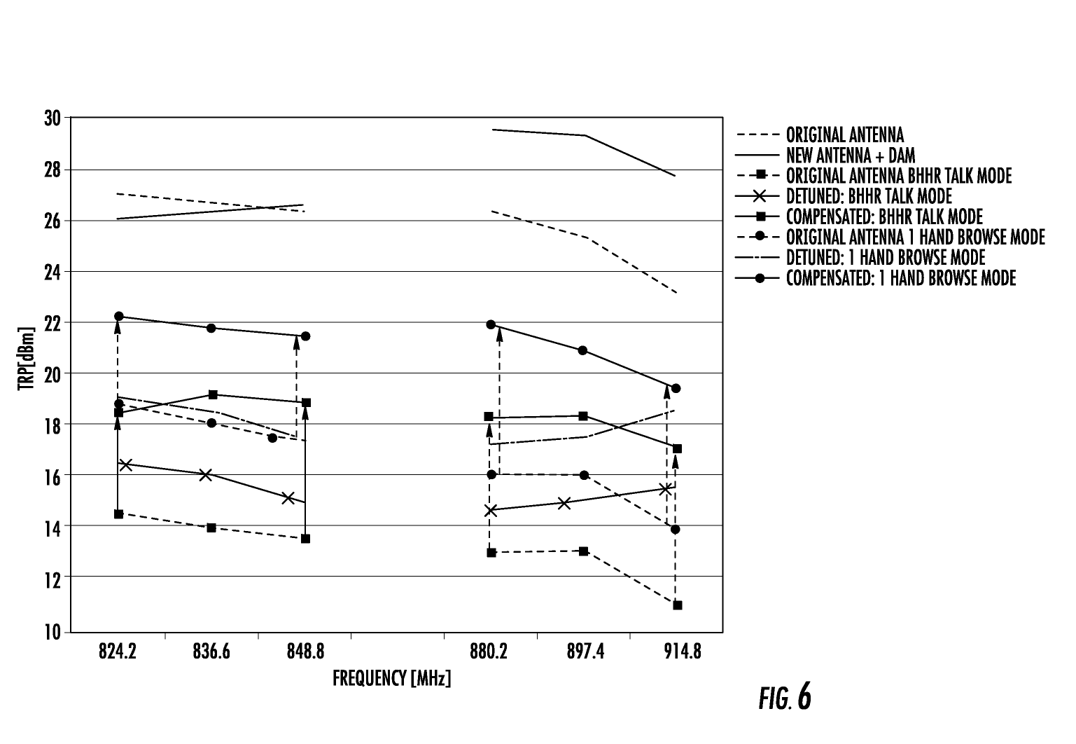

FIG. 6 illustrates exemplary total radiated power (TRP) data for a test setup of the original antenna and the antenna with an exemplary switching antenna apparatus configured according to one embodiment of the present disclosure. The TRP is measured in two operating frequency bands of (i) 824 MHz through 848 MHz, and (ii) 880 MHz through 915 MHz. As illustrated, the antenna under a variety of loading conditions, as well as different device operation modes (e.g. talk mode, browse mode) compensated with the exemplary switching antenna apparatus exhibits markedly improved TRP compared to the original antenna which is not compensated for the loading condition. Specifically, the exemplary figures illustrate the “detuned browse mode”, which corresponds to the exemplary antenna+DAM (in the presence of a user's hand), whereas the “original antenna browse mode” corresponds to the original (uncompensated) antenna in the device with user's hand present.

### CONCLUSION

The various embodiments of the disclosure described above have illustrated the various attributes and improvements provided by the disclosure, which include (without limitation): (i) the ability of the inventive antenna to be located on any side of the host device, and to be tuned to cover the required frequency band(s) for the particular application; (ii) flexibility for literally any switch-based technology to be used (including e.g., GaAs, CMOS, MEMS); (iii) ability to utilize multiple frequency bands and/or feed structures; (iv) ability to utilize flex, ceramic, sheet metal, plated plastic parts, or other technologies for creation of the antenna/radiator; (v) ability to create a plurality of controlled resonance frequencies; (vi) the ability to create a plurality of operating bands associated with one resonance; by using switch elements and certain L-C networks at the switch outputs, one resonance can operate at n frequency bands; (vii) the flexibility to terminate switch outputs with any combination of lumped reactances (discrete L and C) and/or distributed reactances (e.g., transmission lines); (viii) flexibility in operating band switching; i.e., be between different operating bands such as GSM850ÛGSM900 and GSM1800ÛGSM1900 for example. Switching can be also advantageously occur between Tx- and Rx-bands of one system (example 850-Tx and 850-Rx) or any combination of bands and systems which are time multiplexed; (ix) ready compensation for loading which significantly detunes the antenna below the desired band of operation; (x) availability of unlimited number of resonance frequencies which are not tuned by tuning circuit (e.g., parasitic resonator for which frequency is not tuned); and (xi) availability of different filter types (e.g., low-pass, band-pass and band-stop filters), if for example, switching of any of the present frequency bands is to be avoided, and thus perform only switching in some frequency bands.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An antenna circuit for use in a mobile device antenna, comprising:
at least one feed;
a single antenna radiating element;
a transmission path disposed between the at least one feed and the radiating element, the path comprising one or more inductors and one or more nodes;
a first switching apparatus: and
a second switching apparatus:
wherein the first and second switching apparatus are operable to switch among first and second states, respectively, the switching among the first and second states providing at least compensation for dielectric loading of the antenna.

2. The circuit of claim 1, wherein the first and second states comprise different frequency bands of the single antenna radiating element of the antenna circuit.

3. The circuit of claim 1, wherein the first switching apparatus comprises:
at least one first switching element having the first plurality of states; and
at least one filter circuit in electrical communication with the at least one first switching element and disposed electrically between the at least one first switching element and a first of the one or more nodes.

4. The circuit of claim 3, wherein the second switching apparatus comprises:
at least one second switching element having the second plurality of states; and
at least one filter circuit in electrical communication with the at least one second switching element and disposed electrically between the at least one second switching element and a second of the one or more nodes.

5. Switching apparatus for use with an antenna, comprising:
at least one switching element having a plurality of states; and
at least one filter circuit in electrical communication with the at least one switching element and disposed electrically between the switching element and an antenna signal transmission path;
wherein the at least one switching element can be switched between ones of the plurality of states so as to effect respective different operating conditions.

6. The apparatus of claim 5, wherein the different operating conditions comprise different frequency bands of a radiator of the antenna.

7. The apparatus of claim 5, wherein the different operating conditions comprise different dielectric loadings applied to a host device in which the antenna and switching apparatus are disposed.

8. The apparatus of claim 5, wherein the at least one switching element comprises a plurality of semiconductor-based switching elements.

9. The apparatus of claim 8, wherein the semiconductor-based switching elements comprise Gallium Arsenide (GaAs) single pole multi-throw switches.

10. The apparatus of claim 5, wherein the at least one filter circuit comprises a high-pass filter circuit having at least one inductor and at least one capacitor.

11. The apparatus of claim 5, wherein the at least one switching element comprises a plurality of switching elements disposed in electrical series with one another along the transmission path.

12. The apparatus of claim 5, wherein the at least one switching element is configured to receive control inputs from a logical process operative on a host device in which said apparatus is disposed.

13. Multi-band antenna apparatus, comprising:
a feed;
a single radiating element; and
a transmission path between the feed and radiating element, the transmission path comprising switching apparatus in communication therewith but not electrically disposed within the path, the switching apparatus configured to effect changes in electrical length of the radiating element so as to enable operation of the antenna apparatus in two or more desired frequency bands.

14. The antenna apparatus of claim 13, wherein the antenna apparatus is configured to fit within, and be operable in said two or more desired frequency bands of, a low vertical height mobile wireless device having at least one metallic structural component proximate the antenna apparatus.

15. The antenna apparatus of claim 13, wherein placement of the switching apparatus outside of the transmission path provides at least a lower insertion loss as compared to a switch placed in series within the path.

16. Self-compensating antenna apparatus, comprising:
a feed;
a single radiating element;
control apparatus; and
a transmission path between the feed and radiating element, the transmission path comprising switching apparatus in communication therewith, the control apparatus configured to control the switching apparatus to effect changes in electrical length of the radiating element so as to compensate for dielectric loading of the antenna apparatus which detunes the radiating element from its desired operational frequency.

17. The antenna apparatus of claim 16, wherein the control apparatus is selected from the group consisting of: (i) passive circuitry; and (ii) computerized control logic.

18. A mobile wireless device, comprising:
a cellular transceiver;
at least one radiating element in signal communication with the transceiver via a signal transmission path; and
switch circuitry in communication with the transmission path configured to selectively alter the electrical length of the at least one radiating element so as to at least enable: (i) operation in multiple cellular frequency bands of interest; and (ii) compensation for detuning caused by one or more external influences imposed upon the mobile device.

19. An antenna circuit for use in a mobile device antenna, comprising:
at least one feed;
a single antenna radiating element;
a transmission path disposed between the at least one feed and the radiating element, the path comprising first and second inductors, a first node disposed electrically between the first and second inductors, and a second node disposed electrically between the second inductor and the radiating element;
a first switching apparatus comprising:
a first switching element having a first plurality of states; and
at least one filter circuit in electrical communication with the first switching element and disposed electrically between the first switching element and the first node;
a second switching apparatus comprising:
a second switching element having a second plurality of states; and
at least one filter circuit in electrical communication with the second switching element and disposed electrically between the second switching element and the second node.

20. The circuit of claim 19, wherein the first and second switching apparatus are operable to switch among the first and second plurality of states, respectively, so as to allow for at least compensation for dielectric loading of the antenna.
